(19) United States
(12) Patent Application Publication
(10) Pub. No.: US 2020/0384906 A1
(43) Pub. Date: Dec. 10, 2020

(54) Vacuum Tank Liquid Trailer

(71) Applicant: Tracy Earl Troxell, Saginaw, TX (US)

(72) Inventor: Tracy Earl Troxell, Saginaw, TX (US)

(73) Assignee: Troxell Trailer Manufacturing Company, LLC, Saginaw, TX (US)

(21) Appl. No.: 16/431,801

(22) Filed: Jun. 5, 2019

(51) Int. Cl. B60P 1/60; B60P 3/22; B62D 53/08; B62D 27/02; B60S 9/02; B60G 11/00

(52) U.S. Cl. CPC B60P 1/60; B60P 3/221; B62D 53/08; B60R 19/02; B60S 9/02; B60G 11/00; B62D 27/023

(57) ABSTRACT

A vacuum tank semi-trailer having a horizontal tank with front and rear tank heads. A front cantilevered frame is welded to the front tank head and has a fifth wheel hitch and a pair of landing legs fixed thereto. A rear cantilevered frame is welded to the rear tank head, and has an axle assembly sprung therefrom. A lower center of gravity is realized by keeping the front a rear frames smaller than the diameter of the tank. A fill pipe having an upwardly sloped portion to clear the axle assembly is coupled to the tank and presents a fill connection at the rear of the rear frame in a protected manner.

### BACKGROUND OF THE INVENTION

### Related Applications

None.

### Field of the Invention

The present invention relates to semi-trailer tankers. More particularly, the present disclosure relates to a vacuum loading, pressure unloading, tank trailer that has a low center of gravity, and that is useful in oilfield liquid hauling applications.

### DESCRIPTION OF THE RELATED ART

Overland liquid hauling is a routing function associated with oilfield operations. Other than crude oil, water is the predominantly transported oilfield liquid. However, water mixtures, hydrocarbon mixtures, and other oilfield related liquids are also subject to overland transport using semi-trailer tankers. Such liquid transport is applicable in drilling operations, well completion operations, hydrocarbon production, and ongoing well maintenance. Sometimes water is transported to an oilfield for temporary storage in tanks and ponds, or for direct injection into the wells. Sometime water is transported away from the oilfield for disposal, or for other uses.

Liquid loading an unloading facilities employed in oilfield operations are sometimes rather basic, perhaps including just a small tank farm, a single tank, or an open pond, which may or may not have access to grid distributed electrical power. Thus, liquid transport tankers generally require a provision for self-loading and/or self-unloading. This can be accomplished using a semi-trailer tank that is designed to withstand pressure and vacuum, and which is coupled to a compressor, pump, vacuum pump, or such, that applies air pressure or vacuum to the tank to either force liquids out under pressure, or draw liquids in under vacuum. And, these are commonly referred to as “vacuum tank trailers.” It is known in the art to use the power available from the semi-trailer tractor, via PTO, electric, or exhaust driven turbine, to power a pneumatic compressor, which can be plumbed to either apply its output pressure or inlet vacuum to the vacuum tank trailer. This arrangement provides the requisite pressure for unloading or vacuum for loading the tank.

Vacuum tank trailers are presently in use in oilfield operations. These are utilized in all the aforementioned applications, with the transport of hydraulic fracturing liquids being an area of particularly rapid growth in recent years. The prior art vacuum tank trailers are generally configured as semi-trailer tankers where a conventional ladder-type steel frame extends from a fifth wheel hitch at the front end of the trailer to a pair or rear axles assemblies at the rear of the trailer. The ladder frame is support by leaf springs above the axle assemblies. Sometimes, air springs are used to the same effect. Thus, the height of the frame above the ground is determined by the requisite height of the fifth wheel hitch (about 50 to 56 inches) and the combined height the tires, axles, and leaf spring assemblies. This structural arrangement is very common in the design of semi-trailers, as is well known to those skilled in the art. A cylindrical tank rests on top of the ladder frame, and comprises dished tank heads at either end to accommodate the vacuum and pressure forces, with maximums being approximately 25 ponds per square inch (PSI) pressure and 25 inches of mercury (inHg) vacuum. With weight limits set by highway authorities, and based on the density of water, vacuum tank trailers are commonly designed to carry 130 barrels, or 5,460 gallons, of water. This weight is carried in the tank, above the ladder type frame, which sets the center of gravity of the full vacuum tank trailer substantially above the frame height.

It should be recognized that semi-trailers and tractors working in oilfields and related facilities operate on roads and trails that are poorly maintained, often times surfaced with dirt and gravel, and often time subject to erosion from weather. As such, trucks operate on irregular, bumpy, and sloped surfaces. Given the high center of gravity of prior art vacuum tank trailers, designers are forced to employ as small a diameter tank as practicable in order to maintain as low a center of gravity as possible, which necessarily increases the length of the tank to maintain the preferred 130 barrel capacity. Even with this approach, the stability of trailers on poor quality roads is problematic, and roll-over accidents are not infrequent. Thus is can be appreciated that there is a need in the art for an improved vacuum take trailer that addresses the problems in the art.

### SUMMARY OF THE INVENTION

The need in the art is addressed by the apparatuses of the present invention. The present disclosure teaches a vacuum tank semi-trailer for transporting liquid, for use in conjunction with a tractor and a compressor. The semi-trailer includes a tank that has a radius about a horizontally disposed longitudinal axis, with a front tank head and a rear tank head that has a diameter equal to twice the radius. The tank also has a tank connection coupled through the rear tank head that is oriented tangential to the diameter at a lowest position in the rear tank head. A front frame assembly is welded to the front tank head, and has an upper fifth wheel coupler fixed to it, wherein the front frame assembly includes no rigid structural component that is located away from the longitudinal axis a greater distance than the radius. A pair of landing legs are attached to the front frame assembly. The semi-trailer also includes a rear frame assembly that is welded to the rear tank head, which includes a lateral cross member attached to it that is adjacent to the rear end of the rear frame assembly. The the rear frame assembly also includes no rigid structural components that are located away from the longitudinal axis a greater distance than the radius. An axle assembly is spring mounted to the rear frame assembly. The semi-trailer includes a fill pipe that is coupled to the tank connection and routed through the rear frame assembly to present a fill coupling adjacent to the lateral cross member. A pneumatic system is included, which has a compressor coupling for receiving vacuum or air pressure from the compressor, and which is coupled to an upper portion of the tank, to thereby facilitate drawing liquid through the fill coupling, the fill pipe, the tank connection, and into the tank under force of vacuum, and alternatively, to facilitate forcing liquid out of the tank through the tank connection, the fill pipe, and the fill coupling under force of pressure.

In a specific embodiment of the foregoing semi-trailer, the fill pipe includes an upwardly sloped portion that serves to align the fill coupling with the lateral cross member, to thereby locate the fill coupling within the rear frame assembly. In another specific embodiment, the fill pipe includes an upwardly sloped portion that serves to route the fill pipe above the axel assembly to thereby avoid interference with the axle assembly.

In a specific embodiment of the foregoing semi-trailer, the tank further includes a second tank connection located adjacent to the tank connection, and further includes a second fill pipe aligned in parallel with the fill pipe, and coupled to the second tank connection. In another specific embodiment, the fill coupling is located within the rear frame assembly, and the rear frame assembly further includes a bumper that is located at the rear end of the rear frame assembly, and below the fill coupling, to thereby protect the fill coupling while still providing connection access thereto.

In a specific embodiment of the foregoing semi-trailer, the tank has a bottom portion that is lower than either of the front frame assembly and the rear frame assembly. In another specific embodiment, the tractor provides motive power to the compressor, which is coupled to provide vacuum or compressed air to the pneumatic system.

In a specific embodiment, the foregoing semi-trailer further includes a front steel pad disposed between the front tank head and the front frame assembly, which is welded in place, to provide increased structural strength of the connection therebetween, and a rear steel pad disposed between the rear tank head and the rear frame assembly, which is welded in place, to provide increased structural strength of the connection therebetween.

In a refinement to the foregoing specific embodiment, the front tank head and the rear tank head are dished tank heads that are shaped according to ASME specifications, and the front steel pad and the rear steel pad are also dish shaped according to ASME specifications. In addition, the front steel pad and the rear steel pad are slotted and plug welded to the tank, and the frames are butt welded to the pads.

In another refinement to the foregoing specific embodiment, the rear frame assembly further includes a rear elongated box-section gusset disposed laterally between the rear frame assembly and the rear steel pad, to thereby provide lateral stiffening of the rear frame assembly, and, the front frame assembly further includes a front elongated box-section gusset disposed laterally between the front frame assembly and the front steel pad, to thereby provide lateral stiffening of the front frame assembly.

In a specific embodiment of the foregoing semi-trailer, the pneumatic system further includes a centrifugal liquid separator disposed between the compressor coupling and the tank for removing liquid from air evacuated from the tank by the compressor. The centrifugal liquid separator has a drain coupled through a drain valve for selectively draining liquid therefrom, and, a vacuum relief conduit coupled to the pneumatic system, coupled through a vacuum relief valve located adjacent the rear end of the rear frame assembly, for selectively relieving vacuum or pressure within the pneumatic system.

In a specific embodiment of the foregoing semi-trailer, the front frame assembly is configured as a cantilever beam supported only from the front tank head, and, the rear frame assembly is configured as a cantilever beam supported only from the rear tank head.

### BRIEF DESCRIPTION OF THE DRAWINGS

FIG. 1 is a perspective view drawing of a vacuum tank trailer according to an illustrative embodiment of the present invention.

FIG. 2 is a schematic diagram of a vacuum tank trailer according to an illustrative embodiment of the present invention.

FIG. 3 is a side view drawing of a vacuum tank trailer according to an illustrative embodiment of the present invention.

FIG. 4 is a top view drawing of a vacuum tank trailer according to an illustrative embodiment of the present invention.

FIG. 5 is a rear view drawing of a vacuum tank trailer according to an illustrative embodiment of the present invention.

FIG. 6 is a front view drawing of a vacuum tank trailer according to an illustrative embodiment of the present invention.

FIG. 7 is a perspective view drawing of a tank assembly for a vacuum tank trailer according to an illustrative embodiment of the present invention.

FIG. 8 is a partial section view drawing of a tank assembly for a vacuum tank trailer according to an illustrative embodiment of the present invention.

FIG. 9 is a perspective view drawing of a front frame assembly of a vacuum tank trailer tank according to an illustrative embodiment of the present invention.

FIG. 10 is a perspective view drawing of a rear frame assembly of a vacuum tank trailer tank according to an illustrative embodiment of the present invention.

FIG. 11 is a rear view drawing of a rear frame assembly on a vacuum tank trailer tank according to an illustrative embodiment of the present invention.

FIG. 12 is a side view drawing of a rear frame assembly on a vacuum tank trailer tank according to an illustrative embodiment of the present invention.

FIG. 13 is a partial side view drawing of a rear frame assembly for a vacuum tank trailer tank according to an illustrative embodiment of the present invention.

FIG. 14 is a perspective view drawing of a rear frame assembly on a vacuum tank trailer tank according to an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope hereof and additional fields in which the present invention would be of significant utility.

In considering the detailed embodiments of the present invention, it will be observed that the present invention resides primarily in combinations of steps to accomplish various methods or components to form various apparatus and systems. Accordingly, the apparatus and system components, and method steps, have been represented where appropriate by conventional symbols in the drawings, showing only those specific details that are pertinent to understanding the present invention so as not to obscure the disclosure with details that will be readily apparent to those of ordinary skill in the art having the benefit of the disclosures contained herein.

In this disclosure, relational terms such as first and second, top and bottom, upper and lower, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a” does not, without more constraints, preclude the existence of additional identical elements in the process, method, article, or apparatus that comprises the element.

The present disclosure teaches a vacuum tank liquid trailer, which is a type of semi-trailer tanker. The illustrative embodiment provides a low center of gravity. This is accomplished, in part, by utilizing the tank itself as a structural component of the frame, thereby placing the center of mass of the liquid load at a lower position as compared to prior art trailers. This arrangement is made possible through implementation of novel structural and plumbing configurations, which results in a highly integrated design.

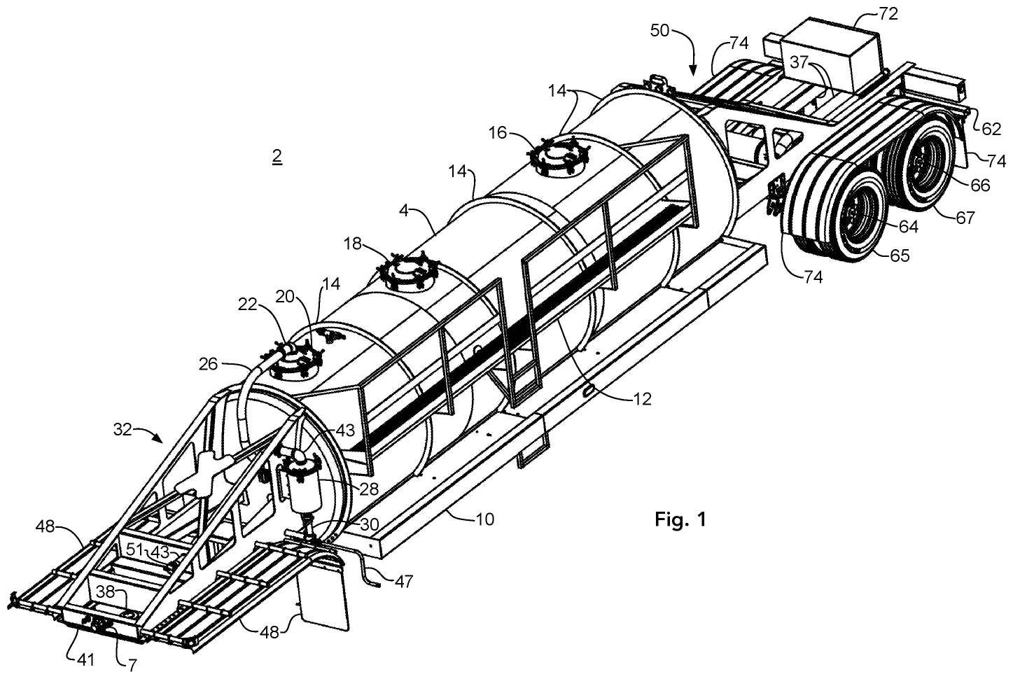

Reference is directed to FIG. 1, which is a perspective view drawing of a vacuum tank trailer 2 according to an illustrative embodiment of the present invention. A tank 4 has affixed thereto a front frame assembly 32 and a rear frame assembly 50. The front frame assembly 32 comprises a fifth wheel coupler, which includes a kingpin 38 disposed upon an upper coupler downward facing bearing plate 41. The kingpin 38 engages a correspond fifth wheel coupler on a host semi-trailer tractor (not shown), as are well known in the art. The rear frame assembly 50 comprises a pair of axle assemblies 64, 66 having corresponding tires 65, 67 mounted thereto. This combination provides the essential semi-trailer structure suitable for overland towing with semi-trailer tractors (not shown).

The tank 4 in FIG. 1 further comprises plural manways 16, 18, 20, at least one of which 20 includes a tank coupling 22 for connecting a tank conduit 26 thereto. The tank 4 further comprises a walkway assembly 12, and at least one hose tray 10, which is useful for storing and transporting hose assemblies (not shown) used for loading and unloading the tank 4. The tank 4 further comprises plural stiffening rings 14 for increasing the strength and rigidity of the tank under structural, pressure, and dynamic loading. Further features of the tank 4 and related components will be more fully described hereinafter.

The front frame assembly in FIG. 1 comprises a pair of fenders 48 and a landing leg assembly 47 (partially visible in FIG. 1). As noted above, an upper coupler bearing plate 41 with kingpin 38 is also positioned at a conventional location. Pneumatic brake and electrical connector interface 7 is also provided at the front end of the front frame assembly 32. A centrifugal liquid separator 28 is positioned on the front frame assembly 32. Tank conduit 26 is connected between the separator 28 and tank coupling 22. Drain pipe 30 is connected to the separator 28 for draining liquids therefrom. Compressor conduit 43 is connected to the separator, and presents a compressor coupling 51 adjacent the front end of the vacuum tank trailer 2, for connection of a compressor (not shown) thereto. Further details of the pneumatic conduit circuits will be more fully discussed hereinafter.

The rear frame assembly 50 in FIG. 1 further comprises a pair of fenders 74 that shield the tires 65, 67. A rear bumper 62 is proved at the end the rear frame assembly 50. A tool box 72 is also provided on an upper surface of the rear frame assembly 50. Routed from the tank 4 and through the rear frame assembly 50 is a pair of tank fill and drain pipes 37, which present a fill and drain coupling (not shown) near the rear of the rear frame assembly 50 for connecting loading and unloading hoses (not shown) thereto.

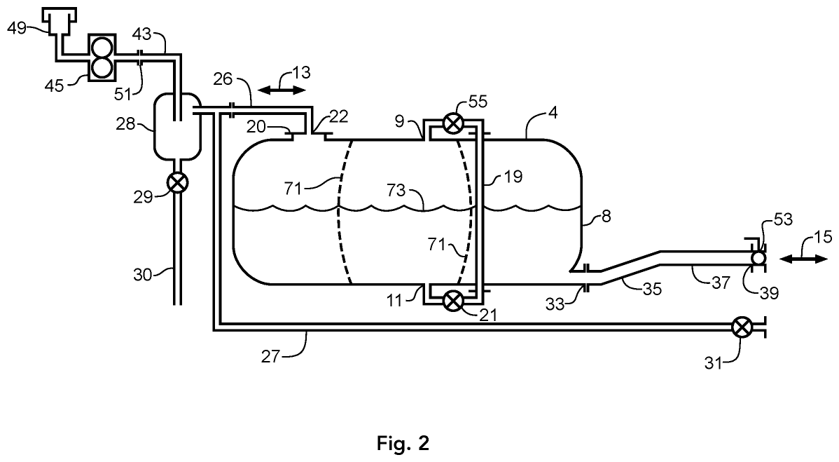

Reference is directed to FIG. 2, which is a schematic diagram of a vacuum tank trailer according to an illustrative embodiment of the present invention. The reference numerals on FIG. 2 generally correspond with the reference numerals on FIG. 1. In FIG. 2, the tank 4 is presented, which is cylindrical steel pressure vessel in the illustrative embodiment. Plural perforated baffles 71 are disposed within the tank 4 to limit the degree of sloshing of the liquids 73 therein during transport. An upper sight glass coupling 9 with an upper sight glass valve 55 are provided, which function cooperatively with a lower sight glass coupling 11 and lower sight glass valve 21, which are joined together by a clear sight glass pipe 19 to enable visual confirmation of the liquid 73 level in the tank 4.

The tank 4 in FIG. 2 has one or more fill and drain pipes 37 connected to one or more corresponding tank connections 33. In the illustrative embodiment, flanged connection(s) are employed. At a distal end of the fill and drain pipe(s) 37, fill and drain coupling(s) 39, with corresponding valve(s) 53, are provided for connection of loading and unloading hose(s) (not shown). In the illustrative embodiment, two fill and drain pipes 37 are provided that are four inches in diameter (nominal pipe size), and the valves 53 are butterfly valves. Note that an upwardly sloped portion(s) 35 of the fill and drain pipe(s) is illustrated. It will be discussed hereinafter that this arrangement facilitates a lower center of gravity for the vacuum tank trailer as well as provision of clearance for axle and suspension components. This arrangement might be viewed as problematic with respect to fully emptying the tank 4 via gravity flow, however, when used in combination with pneumatic pressure evacuation of the liquid 73 in the tank 4, the tank 4 can be fully emptied against the upwardly sloped portion 35 of the fill and drain pipe(s) 37.

FIG. 2 further illustrates the pneumatic circuit of the illustrative embodiment. Air can either be forced into the tank 4 through tank coupling 22, or air can be drawn out of the tank 4 through tank coupling 22. Since the tank 4 is otherwise sealed against pressure and vacuum, except for tank connection(s) 33, the application of air pressure at tank coupling 22 forces the liquid 73 out of the tank 4 through tank connector 33. Conversely, when vacuum is present at tank coupling 22, liquid is drawn into the tank 4 though tank connector 33. This bidirectional feature of the illustrative embodiment is represented in the FIG. 2 by directional arrow 13 for the pneumatic circuit and directional arrow 15 for the liquid circuit. Thusly, the tank 4 can be loaded and filled using vacuum, and unloaded and emptied using air pressure. Both the pressure and vacuum are provided by air compressor 45, which is plumbed, or directionally controlled, to couple either the pressure or suction side of the compressor 45 to tank coupling 22. Various types of compressors, air pumps, vacuum pumps, turbines, and the like can be employed to provide the requisite compression and vacuum functions of the illustrative embodiment and the claimed invention. In this disclosure, the use of the word “compressor” is meant to signify any of them. It is significant the the compressor 45 is powered by the semi-trailer tractor unit (not shown) so that the transfer of liquid into and out of the tank is fully implement by a self contained overland vehicle, without the requirement of any external power source.

Note this editorial comment. To avoid the repetitious use of grammatical articles, including fill and empty, load and unload, inlet and outlet, vacuum and pressure, discharge and draw-in, and the like, for the remainder of this disclosure, the vacuum loading and filling operation will be used as a single exemplary mode of operation. Of course, it will be readily appreciated that the converse operations are also contemplated, as the usefulness of the vacuum tank trailer of the present disclosure relies upon the abilities to both load and fill liquid into tank, and to discharge and empty liquid out of the tank.

The pneumatic circuit of FIG. 2 is primarily designed to couple the compressor 45 to the tank coupling 22. In a typical implementation, the tank 4 is designed and tested for 25-PSI, and operated at approximately 20-PSI, and, designed for 25-inHg of vacuum and operated at approximately 15-inHg of vacuum. The compressor 45 flow rate is approximately 375 cubic feet per minute. Other pressures and volumes can also be employed. The tank volume is approximately 130-barrels. The compressor 45 is coupled from compressor coupling 51 through compressor conduit 43 to the outlet of a centrifugal liquid separator 28. The inlet of separator 28 is coupled to the tank coupling 22 by tank conduit 26. Thus, in vacuum operation, air is drawn out of the tank through tank conduit 26 and into the separator 28. The inlet is tangential to the separator body 28, so any liquid entrained in the flowing air impinges the interior surface and drains to the bottom, while the air exits out to the compressor conduit 43. As liquid collects in the separator 28, it can be drained from the bottom by opening drain valve 29 and flowing out of the separator 28 through drain pipe 30. During pressure operation, no water separation function is provided or needed. One additional feature of the pneumatic circuit is the ability to relief vacuum (or pressure) in the tank 4. This is accomplished by allowing ambient air to flow into the system through vacuum relief conduit 27. This is selectively accomplished by actuating vacuum relief valve 31. Note that vacuum relief line 27 extends to an operator position at the rear of the trailer, where the vacuum relief valve is located. Also note that a muffler 49 is coupled to the compressor 45 to reduce the sound pressure level in the area of operation.

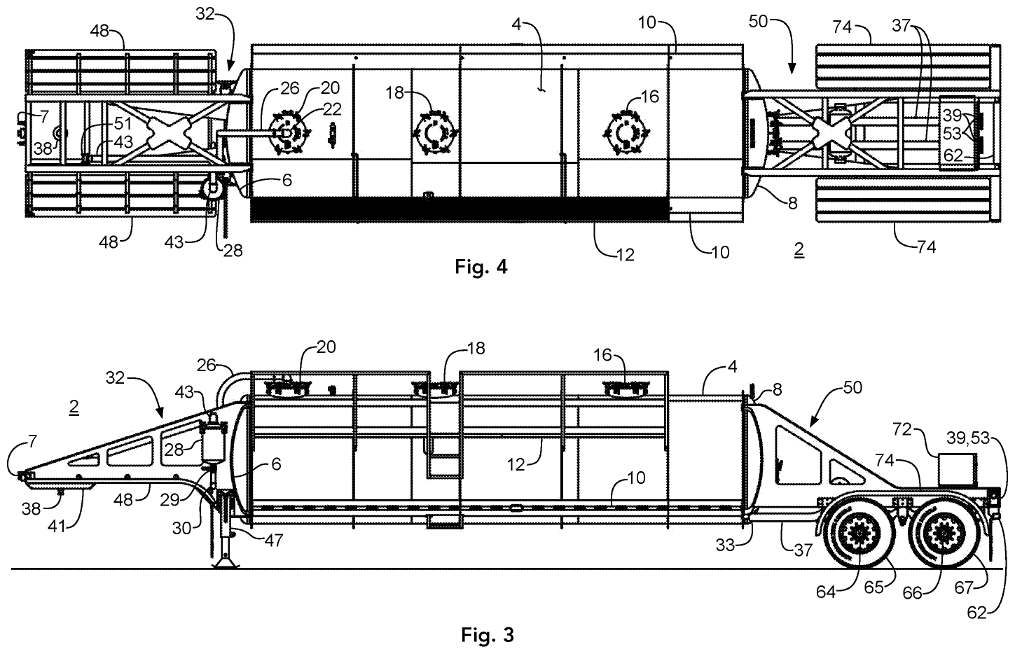

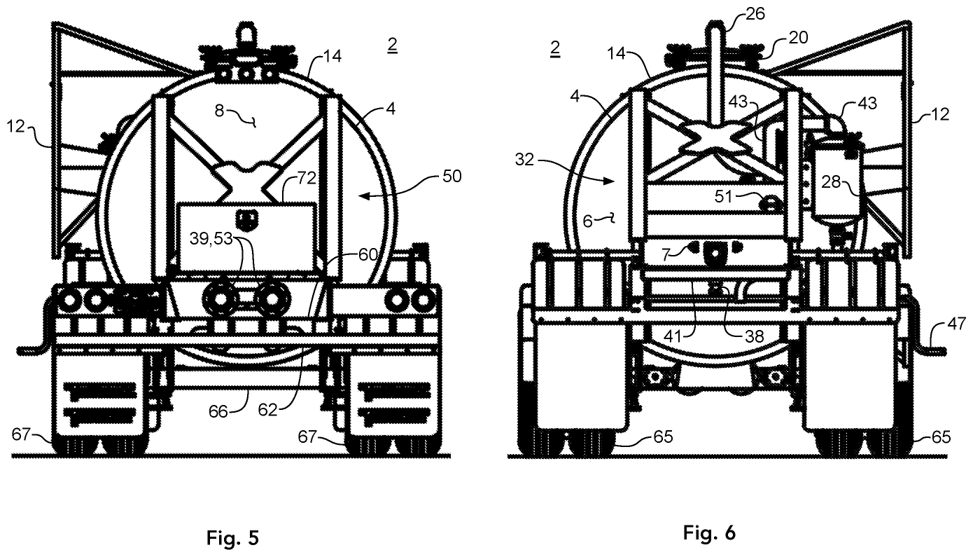

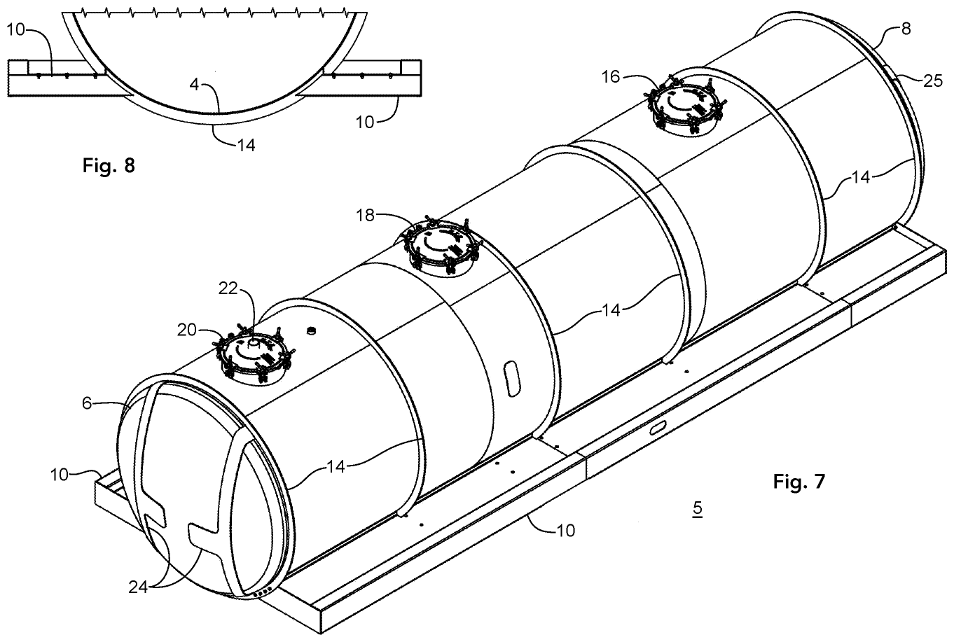

Reference is directed to FIGS. 3, 4, 5, and 6, which are a side view drawing, a top view drawing, a rear view drawing, and a front view drawing, respectively, of a vacuum tank trailer 2 according to an illustrative embodiment of the present invention. Note that the front frame assembly 32 and the rear frame assembly 50 position all of their fixed structural components within the diameter of the tank assembly 4. This feature is most visible in side view FIG. 3 where the lowest point of the tank 4 is lower than either subframe 32, 50. This arrangement enables designers to keep the tank 4 as low as practicable, limited only by the need to proved adequate ground clearance, and thereby maintain the lowest possible center of gravity and the greatest stability of the trailer.

FIGS. 3, 4, 5, and 6 illustrate the cylindrical steel tank 4, which comprises a front dished tank head 6 and a rear dished tank head 8, and which serves as the core structural component of the vacuum tank trailer 2. The tank 4 is reinforced with plural external rolled stiffening rings 14, which strengthen the structure and serve as attachment points for certain sub assemblies discussed hereinafter. A walkway assembly 12 is also provided for access plural manways 16, 18, 20. Hose trays 10 are disposed on either side of the tank 4, for the storage of loading and unloading hoses (not shown).

A front frame assembly 32 is welded to the front dished tank head 6. The front frame assembly 32 acts as a cantilevered strut extending from the front of tank 4, and includes a fifth wheel hitch coupler plate 41 with kingpin 38 for coupling with a semi-trailer tractor (not shown). The front frame assembly serves as the mounting point for a pair of conventional landing leg assemblies 47. An electrical and air brake interface 7 is provided at the front end of the vacuum tank trailer 2 for connection to the tractor unit (not shown). A pair fenders 48 are attached to the front frame assembly 32, to serve the conventional function. Certain of the pneumatic components are mounted to the front frame assembly 32, and these include the liquid separator 28, the liquid drain 30 and drain valve 29, the tank conduit 26, the compressor conduit 43, and the compressor coupling 51, which is positioned near the front of the vacuum tank trailer for connection to a tractor-driven compressor (not shown).

A rear frame assembly 50 is welded to the rear dished tank head 8 and acts as a cantilevered strut extending from the rear of the tank 4, and includes the axles 64, 66, and tires 65, 67. A pair of fenders 74 are attached to the rear frame assembly 50. A tool box 72 is mounted on top of the rear frame assembly 50. A rear bumper 62 is attached to the rear end of the rear frame assembly 50. A pair of 4-inch flanged tank connections 33 extends from the lowest portion of the rear dished tank head 8, and are connected to a pair of 4-inch tank fill pipes 37, which pass through and are supported by a rear cross member 60 of the rear frame assembly 50. The tank fill pipes 37 extend to near the rear end of the rear frame assembly 50 to a pair of fill coupling flanges 39 that have a pair of 4-inch butterfly fill valves 53 attached thereto. These serve as the connection point for attachment of fill hoses (not shown).

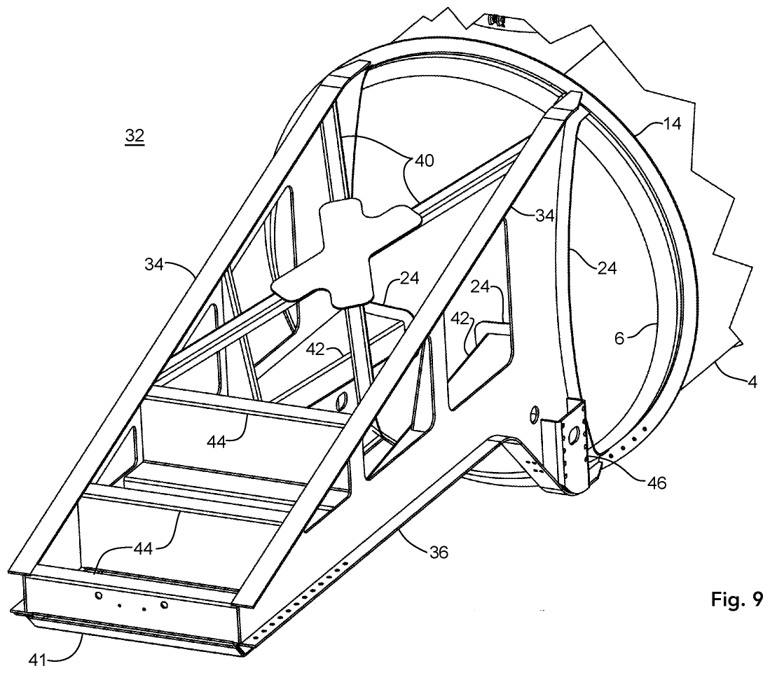

Reference is directed to FIG. 7 and FIG. 8, which are a perspective view drawing and a partial section view drawing, respectively, of a tank assembly 5 for a vacuum tank trailer according to an illustrative embodiment of the present invention. The cylindrical steel tank 4 having the front dished tank head 6 and rear dished tank head 8 welded to its ends forms the liquid containing envelope. In the illustrative embodiment, the tank 4 is 74-inches in diameter and formed from rolled ¼″ ASME SA516 Grade70 steel plate. The dished heads 6, 8 are formed as a non-code ASME dished head shape, using 5/16-inch ¼″ ASME SA516 Grade70 steel plate. Plural rolled steel stiffening rings 14 are added to reinforce the tank assembly 5 to meet the specified pressure and vacuum standards discussed hereinbefore. A pair of hose shelves 10 extend outwardly from either side along a lower portion of the tank assembly 5, and may be attached by welding to the tank 4 and the reinforcing rings 14. Plural manways 16, 18, 20 are attached to the top of the tank 4, and provide access for inspection, cleaning, and repair. One of the manways, 20, has the tank coupling 22 for the pneumatic circuits fixed thereto.

As described hereinbefore, the tank assembly 5 in FIG. 7 serves as the core structural component of the vacuum tank trailer. The front frame assembly (not shown) and the rear frame assembly (not shown) are welded to the front dished head 6 and rear dished head 8, respectively. These frame assemblies are butt welded to the dished heads. In order to accommodate localized tension, bending and shear forces present at the point of welded connection, reinforcing pads 24 are added to the front dished head 6 and reinforcing pads 25 are added to the read dished head 8. These pads 24, 25 are rolled to the same curvatures as the dished heads 6,8 using ¼-inch ASME SA516 Grade70 steel plate. Slots having a width of ⅜-inch and length of 3-inches to 4-inches and spaced about 6-inches apart are formed through the pads 24, 25, which are then plug welded to the dished heads 6, 8 to form thicker composite plate suitable for butt welding the front and rear flame assemblies thereto.

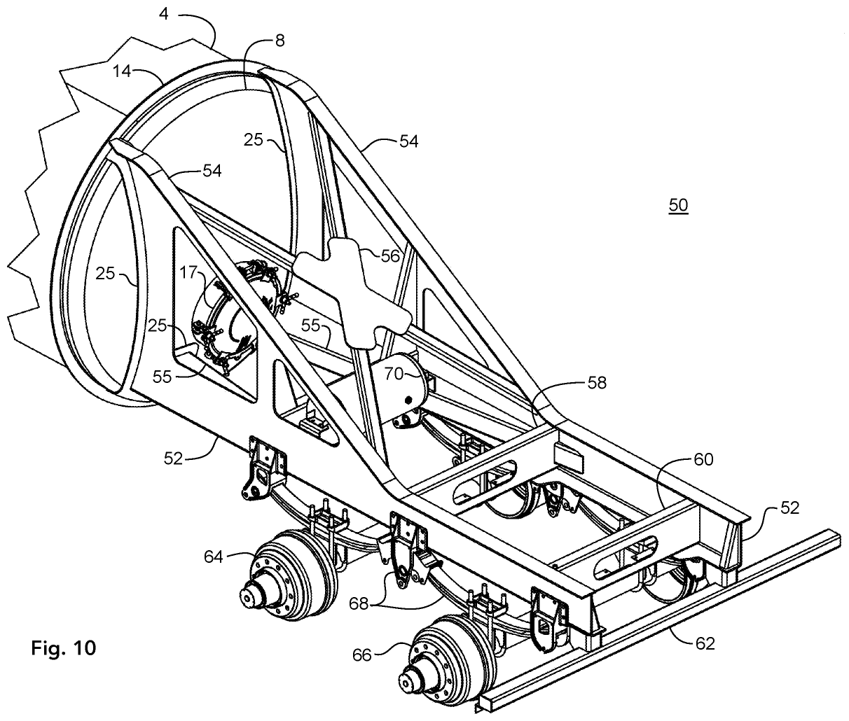

Reference is directed to FIG. 9, which is a perspective view drawing of a front frame assembly 32 of a vacuum tank trailer according to an illustrative embodiment of the present invention. The tank 4, the front dished tank head 6, one of the stiffening rings 14, and the welding pads 24 are visible in this view. The front frame assembly 32 comprises a pair of vertical webbed frame members 34, having a slopped upper surface and a horizontal lower surface 36, and which are curved to match the shape of the front dished tank head 6 and pads 24, for butt welded connection thereto. The webbed frame members are fabricated from ⅜-inch ASME SA516 Grade70 steel plate. A cross brace 40 connects the webbed frame members 34 along the slopped upper surface. Plural cross members 44 are disposed between the webbed frame members 34. The fifth wheel upper coupler plate 41 is attached to the horizontal lower surfaces 36 of the webbed frame members 34 as well as the cross members 44. The vertical orientation of the webbed frame members 34 provides substantial strength along their vertical axis by virtue of the long contact path with the dished tank head 6 on pad 24, but more limited strength along the lateral direction. To augment strength along the lateral direction, elongated box-section gussets 42 are welded between the pads 24 on the dished head 6 and the vertical webbed frame members 34, which substantially strengthen the vertical webbed frame members along the lateral direction. The elongated box-section gussets 42 also distribute the structural loads transferred to the dished head 6 over a larger area, and strengthen that connection as well.

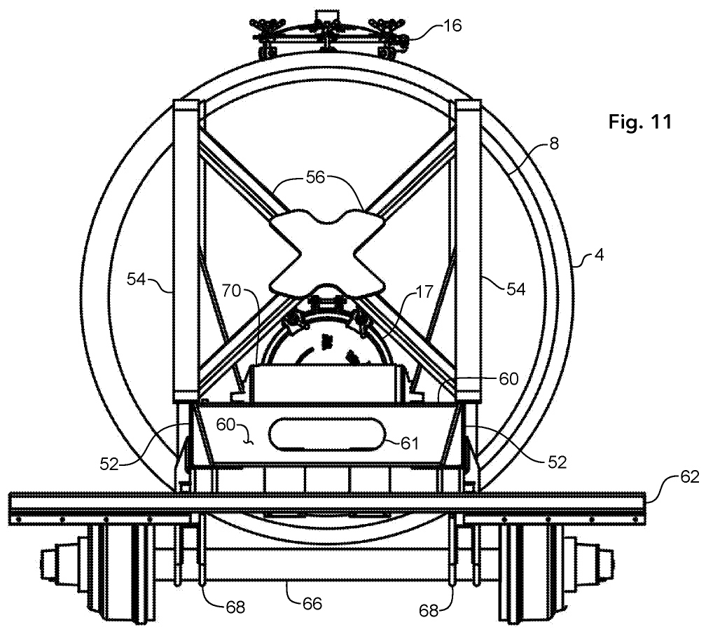

Reference is directed to FIG. 10 and FIG. 11, which are a perspective view drawing and a rear view drawing, respectively, of a rear frame assembly 50 of a vacuum tank trailer tank according to an illustrative embodiment of the present invention. The tank 4, the rear dished tank head 8, one of the stiffening rings 14, and the welding pads 25 are visible in this view. Note that an additional manway 17 is positioned on a lower portion of the rear dished tank head, which provides another access point for service and maintenance. The rear frame assembly 50 comprises a pair of vertical webbed frame members 54, having a slopped upper surface and a horizontal lower surface 52, and which are curved to match the shape of the rear dished tank head 8 and welding pads 25, for butt welded connection thereto. The webbed frame members 54 are fabricated from ⅜-inch ASME SA516 Grade70 steel plate. A cross brace 56 connects the webbed frame members 54 along the slopped upper surface. Plural cross members 58, 60 can be seen and are disposed between the webbed frame members 54. The vertical orientation of the webbed frame members 54 provides substantial strength along their vertical axis by virtue of the long contact path with the dished tank head 8 on pads 25, but more limited strength along the lateral direction. To augment strength along the lateral direction, elongated box-section gussets 55 are welded between the pads 25 on the dished head 8 and the vertical webbed frame members 54, as illustrated, and which substantially strengthen the vertical webbed frame members along the lateral direction. The elongated box-section gussets 55 also distribute the structural loads transferred to the dished head 8 over a larger area, and strengthen that connection as well.

The horizontal lower surface 52 of the pair of vertical webbed frame members 54 is the attachment point for the trailer's rear suspension components, including conventional spring brackets, shackles and leaf springs (collectively 68), and the axles 64, 66. The rear frame assembly 50 further includes an air brake reservoir 70. The rear bumper 62 is disposed between the pair of vertical webbed frame members 54. The rearmost cross member 60 is positioned forward of the rear bumper, and has an opening 61 formed through it, which serves as a port for the fill pipes (not shown), which will be more fully described hereafter.

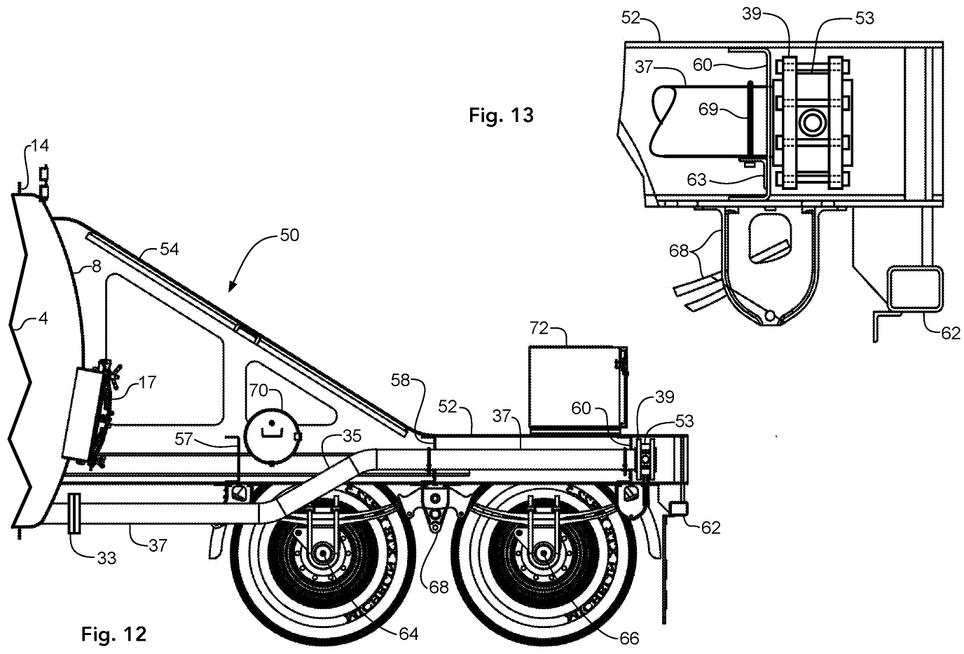

Reference is directed to FIG. 12 and FIG. 13, which are a side view drawing and a partial side view drawing, respectively, of a rear frame assembly 50 on a vacuum tank trailer according to an illustrative embodiment of the present invention. The tank 4, the rear dished tank head 8, one of the stiffening rings 14, and manway 17 are visible in this view. One of the pair of vertical webbed frame members 54 that are curved to match the shape of the rear dished tank head 8 can be clearly seen in this view. Note the location of the air brake reservoir 70 and tool box 72. All of the plural cross members 57, 58, and 60 can be seen in this view. The rear bumper 62 is dispose at the far rear end of the horizontal portion 52 of the pair of vertical webbed frame members 54, and is located below the horizontal portion 52 and below the rearmost cross member 60. Note that the leaf spring assembly 68 is also located below the horizontal portion 52. This arrangement provides clearance for the fill pipes 37 to fit within the depth of the horizontal portion 52 of the webbed frame members 54, and results in a compact structure with a low center of gravity that protects the fill couplings 39 and fill valves 53 by keeping them within the framed space created by webbed frame members 54, cross member 60, and behind the bumper 62, while still providing good access to the fill coupling 39 and fill valves 53. In the illustrative embodiment, the fill couplings 39 are 4-inch pipe flanges and the fill valves 53 are 4-inch flanged mounted butterfly valves, as are known to those skilled in the art.

Now referring to FIG. 12, note that the tank connection 33 is also a 4-inch flange, and that it is located at the very bottom of the tank 4, which enables all of the liquid content of the tank 4 to drain. However, note that the fill coupling 39 is located above the bottom of the tank such that it is located within the depth of the horizontal portion 52 of the webbed frame members 54. Also note that the axles 64, 66 are along the projected centerline of the tank connection 33. The illustrative embodiment the fill pipes 37 comprise and upwardly sloped portion 35 to compensate for the differences in height between the tank connection 33 and the fill coupling 39. Also note that the upwardly sloped portion 35 also routes the fill pipes 37 such that there is no possible interference with the axles 64, 66 even during dynamic vehicle operations. As discussed hereinbefore, the bottom of the tank 4 is the lowest portion of the vacuum tank trailer, which provides the lowest possible center of gravity and the greatest vehicle stability during transit.

Now referring to FIG. 13, details of the fill coupling 39 mount will be discussed. The fill pipe 37 is routed within the depth of the horizontal portion 52 of the rear frame assembly (50 in FIG. 12). The rear most cross member 60 includes a mounting bracket 63 and a U-bolt clamp 69, which engages and secures the fill pipes 37 and the fill couplings 39. The fill valves 53 are attached to the fill couplings 39. The fill valves 53 are located behind the bumper 62, yet are readily accessible from the rear of the the trailer for operation of the fill valves and connection of fill hoses (not shown) thereto. In this manner, the fill couplings 39 and fill valves 53 are protected from impact and damaged during operation.

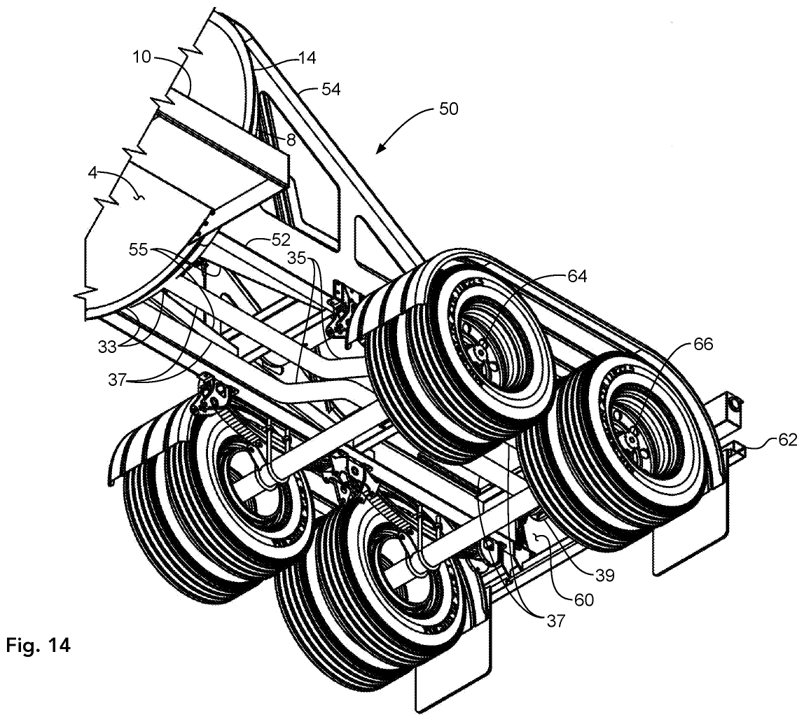

Reference is directed to FIG. 14, which is a perspective view drawing of a rear frame assembly 50 on a vacuum tank trailer tank according to an illustrative embodiment of the present invention. This view provides another perspective on how the various components are arranged to provide an efficient, compact trailer with a low center of gravity. The webbed frame members 54 are attached to the read dished tank head 8 and laterally braced by elongated box-section gussets 55. The tank connection 33 pipes are at the bottom of the tank. The tank fill pipes 37 are routed upwardly along upwardly sloped portion 35 and clear the axles 64, 66, and extend rearward through frame cross member 60 where the fill couplings 39 are located.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A vacuum tank semi-trailer for use in conjunction with a tractor and a compressor to transport liquid, comprising:
a tank having a radius about a horizontally disposed longitudinal axis, and having a front tank head and a rear tank head having a diameter equal to twice said radius, and having a tank connection coupled through said rear tank head, and oriented tangential to said diameter at a lowest position thereon;
a front frame assembly welded to said front tank head, and having an upper fifth wheel coupler fixed thereto, wherein said front frame assembly comprises no rigid structural component located away from said longitudinal axis a greater distance than said radius;
a pair of landing legs attached to said front frame assembly;
a rear frame assembly welded to said rear tank head, having a lateral cross member fixed thereto adjacent a rear end of said rear frame assembly, wherein said rear frame assembly comprises no rigid structural component located away from said longitudinal axis a greater distance than said radius;
an axle assembly spring mounted to said rear frame assembly;
a fill pipe coupled to said tank connection and routed through said rear frame assembly to present a fill coupling adjacent said lateral cross member, and
a pneumatic system having a compressor coupling for receiving vacuum or air pressure from the compressor, and coupled to an upper portion of said tank, to thereby facilitate drawing liquid through said fill coupling, said fill pipe, said tank connection, and into said tank under force of vacuum, and alternatively, to facilitate forcing liquid out of said tank through said tank connection, said fill pipe, and said fill coupling under force of pressure.

2. The vacuum tank semi-trailer of claim 1, and wherein:
said fill pipe comprises an upwardly sloped portion that serves to align said fill coupling with said lateral cross member, to thereby locate said fill coupling within said rear frame assembly.

3. The vacuum tank semi-trailer of claim 1, and wherein:
said fill pipe comprises an upwardly sloped portion that serves to route said fill pipe above said axel assembly to thereby avoid interference therewith.

4. The vacuum tank semi-trailer of claim 1, and wherein:
said tank further comprises a second tank connection located adjacent said tank connection, further comprising;
a second fill pipe aligned in parallel with said fill pipe, and coupled to said second tank connection.

5. The vacuum tank semi-trailer of claim 1, and wherein:
said fill coupling is located within said rear frame assembly, and wherein
said rear frame assembly further comprises a bumper that is located at said rear end of said rear frame assembly, and below said fill coupling, to thereby protect said fill coupling while providing connection access thereto.

6. The vacuum tank semi-trailer of claim 1, and wherein:
said tank has a bottom portion that is lower than either of said front frame assembly and said rear frame assembly.

7. The vacuum tank semi-trailer of claim 1, and wherein:
the tractor provides motive power to the compressor that is coupled to provide vacuum or compressed air to said pneumatic system.

8. The vacuum tank semi-trailer of claim 1, further comprising:
a front steel pad disposed between said front tank head and said front frame assembly, which is welded in place, to provide increased structural strength of the connection therebetween, and
a rear steel pad disposed between said rear tank head and said rear frame assembly, which is welded in place, to provide increased structural strength of the connection therebetween.

9. The vacuum tank semi-trailer of claim 9, and wherein:
said front tank head and said rear tank head are dished tank heads that are shaped according to ASME specifications, and wherein
said front steel pad and said rear steel pad are also dish shaped according to ASME specifications, and wherein
said front steel pad and said rear steel pad are slotted and plug welded to said tank, and wherein
said frames are butt welded to said pads.

10. The vacuum tank semi-trailer of claim 8, and wherein:
said rear frame assembly further comprises a rear elongated box-section gusset disposed laterally between said rear frame assembly and said rear steel pad, to thereby provide lateral stiffening of said rear frame assembly, and wherein
said front frame assembly further comprises a front elongated box-section gusset disposed laterally between said front frame assembly and said front steel pad, to thereby provide lateral stiffening of said front frame assembly.

11. The vacuum tank semi-trailer of claim 1, and wherein said pneumatic system further comprises:
a centrifugal liquid separator disposed between said compressor coupling and said tank for removing liquid from air evacuated from said tank by the compressor, said centrifugal liquid separator having a drain coupled through a drain valve for selectively draining liquid therefrom, and
a vacuum relief conduit coupled to said pneumatic system, coupled through a vacuum relief valve located adjacent said rear end of said rear frame assembly, for selectively relieving vacuum or pressure within said pneumatic system.

12. The vacuum tank semi-trailer of claim 1, and wherein:
said front frame assembly is configured as a cantilever bean supported only from said front tank head, and wherein
said rear frame assembly is configured as a cantilever beam supported only from said rear tank head.
